(19) United States
(12) Patent Application Publication
(10) Pub. No.: US 2026/0180630 A1
(43) Pub. Date: Jun. 25, 2026

(54) DYNAMIC ANALOG BEAMFORMING

(71) Applicant: QUALCOMM Incorporated, San Diego, CA (US)

(72) Inventors: Francesco GATTA, San Diego, CA (US); Valibabu SALADI, San Diego, CA (US); Vasanthan RAGHAVAN, West Windsor Township, NJ (US); Raghu Narayan CHALLA, San Diego, CA (US); Varish DIDDI, San Diego, CA (US); Harish VENKATACHARI, San Jose, CA (US); Naushad DHAMANI, San Diego, CA (US)

(21) Appl. No.: 18/990,054

(22) Filed: Dec. 20, 2024

(51) Int. Cl. H04B 7/0426; H01Q 3/34; H04B 1/16

(52) U.S. Cl. CPC H04B 7/043; H01Q 3/34; H04B 1/1615

(57) ABSTRACT

Certain aspects of the present disclosure provide techniques for dynamic analog beamforming. An example method of wireless communications includes feeding, via a switch circuit, a first signal to a first amplifier and a second signal to a second amplifier. The method further includes feeding a third signal to a first phase shifter via the first amplifier and a fourth signal to a second phase shifter via the second amplifier based at least in part on switching from a first state to a second state of the receiver. The method further includes applying a first phase shift to the third signal and a second phase shift to the fourth signal. The method further includes combining, into a combined signal, the phase shifted third signal and the phase shifted fourth signal. The method further includes feeding the combined signal to one of a plurality of circuit outputs.

### INTRODUCTION

### Field of the Disclosure

Aspects of the present disclosure relate to wireless communications, and more particularly, to analog beamforming.

### Description of Related Art

Wireless communications systems are widely deployed to provide various telecommunication services such as telephony, video, data, messaging, broadcasts, etc. These wireless communications systems may employ multiple-access technologies capable of supporting communications with multiple users by sharing available wireless communications system resources with those users. Wireless communication devices may communicate radio frequency (RF) signals via any of various suitable radio access technologies (RATs) including, but not limited to, 5G New Radio (NR), Evolved Universal Terrestrial Radio Access (E-UTRA), Code Division Multiple Access (CDMA), Time Division Multiple Access (TDMA), Wideband CDMA (WCDMA), Global System for Mobility (GSM), Bluetooth, Bluetooth Low Energy (BLE), ZigBee, wireless local area network (WLAN) RATs (e.g., Institute of Electrical and Electronics Engineers (IEEE) 802.11 specifications), any future RAT, and/or the like.

In certain cases, a wireless communications device is equipped with a RF transceiver (also referred to as an RF front-end) for communicating RF signals. In general, a baseband signal is modulated to convey information using a modulation technique, such as phase-shift keying (PSK) or any other suitable modulation technique. In a transmit mode, the RF transceiver is responsible for multiplexing the baseband signal with an RF carrier signal that is transmitted over the air (e.g., a wireless communication channel). Such an operation is called upconversion. In a receive mode, the RF transceiver converts a received RF signal to the baseband signal. Such an operation is called downconversion. The received baseband signal then can be demodulated into the information encoded at a transmitter. The RF transceiver may include a cascade of components in a transmit chain and a receive chain, respectively. The cascade of components may include, for example, one or more of attenuators, switches, couplers, filters, mixers, amplifiers, frequency synthesizers, oscillators, antenna tuners, duplexers, diplexers, detectors, etc.

Although there have been great technological advancements in RF circuitry over many years, challenges still exist, such as effective usage of antenna-receive path combinations. Accordingly, there is a continuous desire to improve the technical performance of RF circuitry.

### SUMMARY

Certain aspects provide a receiver configured for wireless communications. The receiver includes a plurality of amplifiers comprising a first amplifier and a second amplifier. The receiver includes a first switch circuit coupled to the plurality of amplifiers, wherein the first switch circuit is configured to selectively couple one or more antennas to at least one of the plurality of amplifiers. The receiver further includes a plurality of phase shifters comprising a first phase shifter coupled to at least the first amplifier, and a second phase shifter coupled to at least the second amplifier. The receiver further includes a radio frequency combiner coupled to the plurality of phase shifters. The receiver further includes one or more memories and one or more processors coupled to the one or more memories, the first phase shifter, and the second phase shifter. The one or more processors are configured to cause the receiver to feed a first signal to the first phase shifter via the first amplifier and a second signal to the second phase shifter via the second amplifier based at least in part on switching from a first state to a second state of the receiver; apply a first phase shift to the first signal and a second phase shift to the second signal; combine, into a combined signal, the phase shifted first signal and the phase shifted the second signal; and feed the combined signal to one of a plurality of circuit outputs.

Certain aspects provide a method of wireless communications by a receiver. The method includes feeding, via a switch circuit, a first signal to a first amplifier and a second signal to a second amplifier. The method further includes feeding a third signal to a first phase shifter via the first amplifier and a fourth signal to the second phase shifter via the second amplifier based at least in part on switching from a first state to a second state of the receiver. The method further includes applying a first phase shift to the third signal and a second phase shift to the fourth signal. The method further includes combining, into a combined signal, the phase shifted third signal and the phase shifted fourth signal. The method further includes feeding the combined signal to one of a plurality of circuit outputs.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 depicts an example wireless communications system.

FIG. 2 depicts an example wireless communications device communicating with another device.

FIG. 3 depicts an example receiver architecture that employs dynamic analog beamforming for wireless communications.

FIG. 4 depicts an example phase shifter architecture for dynamic analog beamforming.

FIG. 5 depicts an example antenna architecture for dynamic analog beamforming.

FIG. 6 depicts an example method for wireless communications by a receiver.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatus, methods, processing systems, and computer-readable mediums for dynamic analog beamforming.

Certain wireless communication systems (e.g., 5G New Radio (NR) systems) may allow for multiple-input and multiple-output (MIMO) communications between devices, such as a user equipment (UE) and a network entity (e.g., base station). MIMO communications may involve transmission of multiple streams of traffic via the same set of subcarriers at the same time, for example, using multiple antennas at both the transmitter and receiver. The different streams of traffic may be referred to as MIMO layers. A MIMO layer may correspond to a data or traffic stream communicated via spatial multiplexing using multiple antennas at both the transmitter and receiver. For 5G NR systems, the transceiver of a UE may be capable of receiving up to a certain number of MIMO layers (e.g., four MIMO layers) for single-user MIMO downlink communications within the same frequency band. For example, the UE transceiver may have multiple receive paths (e.g., up to eight receive paths for a frequency band), where each of the receive paths can be coupled to a different antenna and carry a different traffic stream (e.g., MIMO layer) for single-user MIMO downlink communications.

Technical problems for MIMO communications include, for example, effective usage of the antenna-receive path combinations at a UE when the UE is allocated a subset of downlink MIMO layers for wireless communications. Due to various factors that may change over time (e.g., signal quality, channel conditions, channel capacity, transmission range, power consumption, or the like), the UE may communicate with a base station via a subset of downlink MIMO layers using a single antenna-receive path combination per MIMO layer. The peak achievable throughput may depend on the number of MIMO layers allocated for the transmission and the number of antennas used for reception of the MIMO layers at the UE. As an example, the UE may communicate via one to three MIMO layers out of four MIMO layers supported by the UE while using at least an antenna-receive path combination per MIMO layer (e.g., each of one to four antennas coupled to a respective receive path). In certain cases, the UE may receive transmissions using the same number of receive path(s) and antenna(s) as the total number of MIMO layer(s) allocated for the transmission, while having unused receive path(s) and/or antenna(s) available for wireless communications. Accordingly, when the UE communicates via a subset of downlink MIMO layers, the UE may encounter a peak throughput based on the number of antennas used for reception of the transmission.

Certain aspects described herein overcome the aforementioned technical problem(s), for example, by providing techniques for dynamic analog beamforming for a multi-input receiver. In certain aspects, a receiver may be configured to receive signaling using dynamic analog beamforming, which may enable the receiver to opportunistically use extra antenna(s) for reception of signaling on a MIMO layer and increase the peak throughput for the MIMO layer. Dynamic analog beamforming may refer to the receiver selectively switching between analog beamforming and using a single antenna-receive path combination for a MIMO layer depending on certain criteria. The receiver may receive signaling on a MIMO layer using analog beamforming when extra antennas are available for reception, for example, when a subset of downlink MIMO layers are allocated for a transmission. As an example, the receiver may include an array of amplifiers and phase shifters that feed signaling from different antennas into a radio frequency combiner to perform the analog beamforming. The criteria may include, for example, a received signal quality, a received signal strength, antenna diversity, the number of MIMO layers allocated for a transmission, a level of power usage for the transmission, or the like. In certain aspects, the receiver may select the antennas used for the analog beamforming, for example, depending on the signal quality encountered at the antennas.

Certain techniques for dynamic analog beamforming described herein may provide various beneficial technical effects and/or advantages. The techniques for dynamic analog beamforming may enable improved wireless communication performance, such as increased throughput, improved power consumption, additional levels of throughput, and/or the like. The improved wireless communication performance may be attributable to the dynamic analog beamforming described herein that allows improved received signal qualities for communications using a subset of MIMO layers. As an example, the dynamic analog beamforming may enable a receiver to use a subset of receive paths (which consume less power relative to using all of the receive paths) to achieve improved received signal qualities for communications. In certain cases, the dynamic analog beamforming may enable intermediate levels of throughput between throughputs achieved using an antenna-receive path combination per MIMO layer.

### Example Wireless Communications System

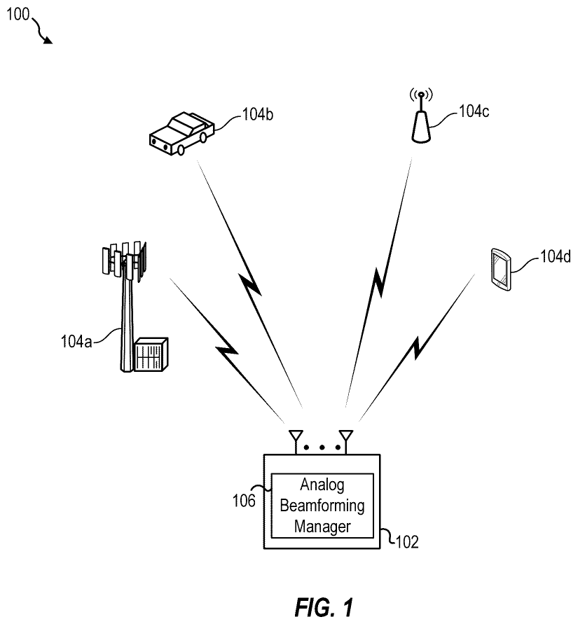

FIG. 1 illustrates an example wireless communications system 100 in which aspects of the present disclosure may be performed. For example, the wireless communications system 100 may include a wireless wide area network (WWAN) and/or a wireless local area network (WLAN). A WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G) or Third Generation (3G) network), a code division multiple access (CDMA) system (e.g., a 2G/3G network), any future WWAN system, or any combination thereof. A WLAN may include a wireless network configured for communications according to an Institute of Electrical and Electronics Engineers (IEEE) standard such as one or more of the 802.11 standards, etc. In some cases, the wireless communications system 100 may include a device-to-device (D2D) communications network or a short-range communications system, such as Bluetooth communications or near field communications (NFC).

As illustrated in FIG. 1, the wireless communications system 100 may include a first wireless device 102 communicating with any of various second wireless devices 104a-d (hereinafter “the second wireless device 104”) via any of various radio access technologies (RATs), where a wireless device may refer to a wireless communications device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), etc.

The first wireless device 102 may include any of various wireless communications devices including a user equipment (UE), a base station, a wireless station, an access point, customer-premises equipment (CPE), etc. In certain aspects, the first wireless device 102 includes an analog beamforming manager 106 that may control analog beamforming applied at a receiver, for example, opportunistically depending on a received signal quality, a received signal strength, antenna diversity, the number of MIMO layers allocated for a transmission, a level of power usage for the transmission, or the like, in accordance with aspects of the present disclosure.

The second wireless device 104 may include, for example, a base station 104a, a vehicle 104b, an access point (AP) 104c, and/or a UE 104d. Further, the wireless communications systems 100 may include terrestrial aspects, such as ground-based network entities (e.g., the base station 104a and/or access point 104c), and/or non-terrestrial aspects, such as a spaceborne platform and/or an aerial platform, which may include network entities on-board (e.g., one or more base stations) capable of communicating with other network elements (e.g., terrestrial base stations) and/or user equipment.

The base station 104a may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 and/or the UE 104d may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. A UE may also be referred to more generally as a mobile device, a wireless device, a wireless communications device, a wireless station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

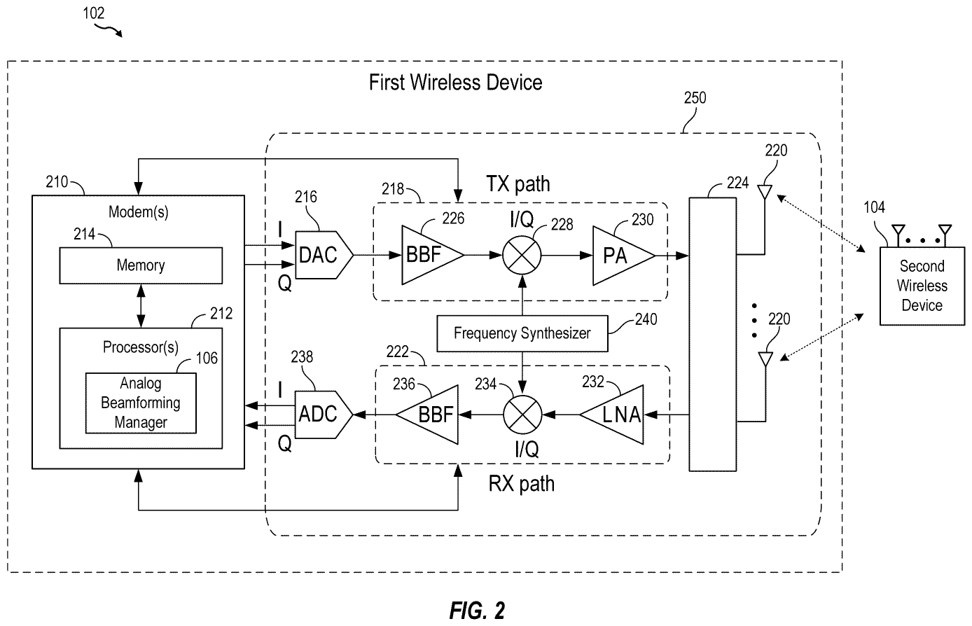

FIG. 2 illustrates example components of the first wireless device 102, which may be used to communicate with any of the second wireless devices 104.

The first wireless device 102 may be, or may include, a chip, system on chip (SoC), system in package (SiP), chipset, package, device that includes one or more modems 210 (hereinafter “the modem 210”). In some cases, the modem 210 may include, for example, any of a WWAN modem (e.g., a modem configured to communicate via E-UTRA, 5G NR, and/or any future WWAN communications standards), a WLAN modem (e.g., a modem configured to communicate via IEEE 802.11 standards), a Bluetooth modem, a NTN modem, etc. In certain aspects, the first wireless device 102 also includes one or more RF transceivers (hereinafter “the RF transceiver 250”). In some cases, the RF transceiver 250 or a portion thereof may be referred to as an RF front end (RFFE). In some aspects, the modem 210 further includes one or more processors, processing blocks or processing elements (hereinafter “the processor 212”) and one or more memory blocks or elements (hereinafter “the memory 214”). In some cases, the processor 212 may implement and/or include the analog beamforming manager 106. In certain aspects, the processor 212 and/or the memory 214 are implemented external or otherwise separate from the modem 210.

In certain aspects, the processor 212 may process any of certain protocol stack layers associated with a radio access technology (RAT). For example, the processor 212 may process any of an application layer, packet layer, WLAN protocol stack layers (e.g., a link or a medium access control (MAC) layer), and/or WWAN protocol stack layers (e.g., a radio resource control (RRC) layer, a packet data convergence protocol (PDCP) layer, a radio link control (RLC) layer, and a MAC layer).

The modem 210 may generally be configured to implement a physical (PHY) layer. For example, the modem 210 may be configured to modulate packets and to output the modulated packets to the RF transceiver 250 for transmission over a wireless medium. The modem 210 is similarly configured to obtain modulated packets received by the RF transceiver 250 and to demodulate the packets to provide demodulated packets. In addition to a modulator and a demodulator, the modem 210 may further include digital signal processing (DSP) circuitry, automatic gain control (AGC), a coder, a decoder, a multiplexer, and/or a demultiplexer (not shown).

As an example, while in a transmission mode, the modem 210 may obtain data from a data source, such as an application processor. The data may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 216. In certain aspects involving beamforming, the modulated symbols in the respective spatial streams may be precoded via a steering matrix prior to provision to the IFFT block.

The modem 210 may be coupled to the RF transceiver 250 by a transmit (TX) path 218 (also known as a transmit chain) for transmitting signals via one or more antennas 220 (hereinafter “the antennas 220”) and a receive (RX) path 222 (also known as a receive chain) for receiving signals via the antennas 220. When the TX path 218 and the RX path 222 share the antennas 220, the paths may be coupled to the antennas 220 via an interface 224, which may include any of various suitable RF devices, such as a balun, a transformer, an antenna tuner, a switch, a duplexer, a diplexer, a multiplexer, and the like. As an example, the modem 210 may output digital in-phase (I) and/or quadrature (Q) baseband signals representative of the respective symbols to the DAC 216. In some examples, all or most of the elements illustrated as being included in the RF transceiver 250 are implemented in a single chip or die. For example, in some configurations, all of the elements of the RF transceiver except the antennas 220 are implemented on a single chip. In some other configurations, the interface 224 or a portion thereof and/or a power amplifier 230 is also omitted from the single chip. In some examples, the single chip is referred to as a transceiver chip.

Receiving I or Q baseband analog signals from the DAC 216, the TX path 218 may include a baseband filter (BBF) 226, a mixer 228 (which may include one or several mixers), and the power amplifier (PA) 230. The BBF 226 filters the baseband signals received from the DAC 216, and the mixer 228 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 228 are typically RF signals, which may be amplified by the PA 230 before transmission by the antennas 220. The antennas 220 may emit RF signals, which may be received at the second wireless device 104. While one mixer 228 is illustrated, several mixers may be used to upconvert the filtered baseband signals to one or more intermediate frequencies and to thereafter upconvert the intermediate frequency signals to a frequency for transmission.

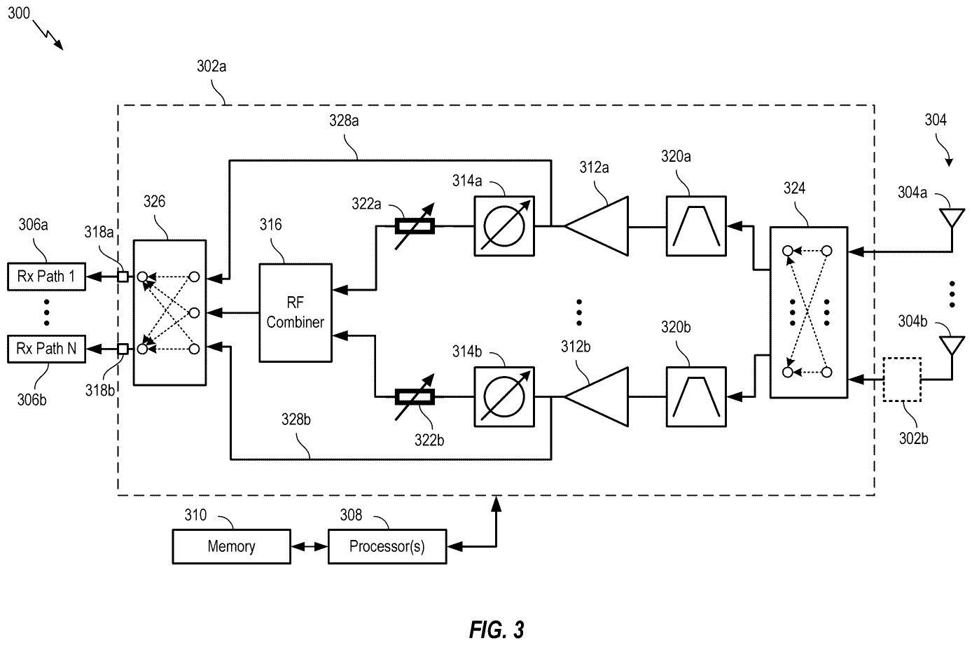

The RX path 222 may include a low noise amplifier (LNA) 232, a mixer 234 (which may include one or several mixers), and a baseband filter (BBF) 236. In certain cases, the LNA 232 may be or include amplifier circuitry configured to perform dynamic analog beamforming, for example, as further described herein with respect to FIGS. 3-6. In other examples, circuitry external to the LNA 232 (e.g., external to the single transceiver chip, but still within the first wireless device 102) is configured to perform dynamic analog beamforming and the output(s) of such external circuitry are coupled to respective LNA(s) 232/RX paths 222. RF signals received via the antennas 220 (e.g., from the second wireless device 104) may be amplified by the LNA 232, and the mixer 234 mixes the amplified RF signals with a receive local oscillator (LO) signal to convert the RF signal to a baseband frequency (e.g., downconvert). The baseband signals output by the mixer 234 may be filtered by the BBF 236 before being converted by an analog-to-digital converter (ADC) 238 to digital I or Q signals for digital signal processing. The modem 210 may receive the digital I or Q signals and further process the digital signals, for example, demodulating the digital signals into information.

Certain transceivers may employ frequency synthesizers with a voltage-controlled oscillator (VCO) to generate a stable, tunable LO frequency with a particular tuning range. Thus, the transmit LO frequency may be produced by a frequency synthesizer 240, which may be buffered or amplified by an amplifier (not shown) before being mixed with the baseband signals in the mixer 228. Similarly, the receive LO frequency may be produced by the frequency synthesizer 240, which may be buffered or amplified by an amplifier (not shown) before being mixed with the RF signals in the mixer 234. Separate frequency synthesizers may be used for the TX path 218 and the RX path 222.

While in a reception mode, the modem 210 may obtain digitally converted signals via the ADC 238 and RX path 222. As an example, in the modem 210, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 212) for processing, evaluation, or interpretation.

The modem 210 and/or processor 212 may control the transmission of signals via the TX path 218 and/or reception of signals via the RX path 222. In some aspects, the modem 210 and/or processor 212 may be configured to perform various operations, such as those associated with any of the methods described herein. The modem 210 and/or processor 212 may include a microcontroller, a microprocessor, an application processor, a baseband processor, a MAC processor, an artificial intelligence (AI) processor, a digital signal processor (DSP), an application specific integrated circuit (ASIC), a field programmable gate array (FPGA) or other programmable logic device (PLD), discrete gate or transistor logic, discrete hardware components, or any combination thereof. The memory 214 may store data and program codes (e.g., processor-readable instructions) for performing wireless communications as described herein. In some cases, the memory 214 may be external to the modem 210 and/or processor 212 and/or incorporated therein (as illustrated with the memory 214 or being incorporated with the processor 212).

FIG. 2 shows an example transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted. For example, it will be understood by those skilled in the art that certain details of a wireless device are omitted from FIG. 2 for ease of illustration.

### Example Dynamic Analog Beamforming

Aspects of the present disclosure provide techniques for dynamic analog beamforming. In certain aspects, a receiver may be configured to dynamically perform analog beamforming, for example, opportunistically depending on a received signal quality, a received signal strength, antenna diversity, the number of MIMO layers allocated for a transmission, a level of power usage for the transmission, and/or the like. The dynamic analog beamforming may enable improved wireless communication performance, such as increased throughput, improved power consumption, additional levels of throughput, and/or the like.

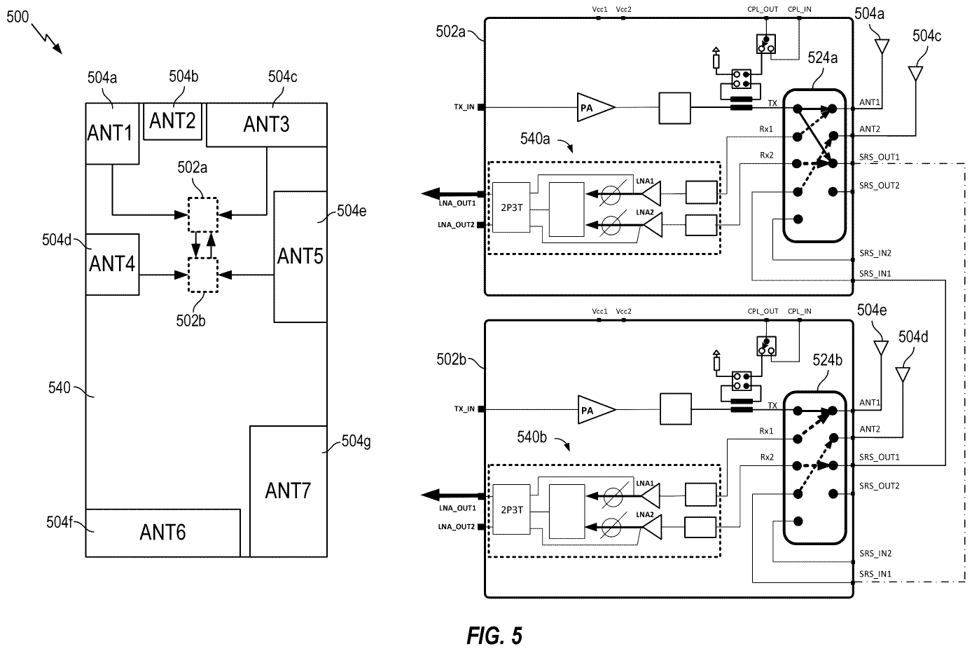

FIG. 3 depicts an example receiver architecture (hereinafter “the receiver 300”) that employs dynamic analog beamforming for wireless communications. The receiver 300 may be an example of a receiver included in the RF transceiver 250 of FIG. 2. In certain aspects, the receiver 300 may be configured to perform dynamic analog beamforming in certain frequency range(s), such as Frequency Range 1 (FR1) and/or Frequency Range 3 (FR3) as specified for 5G NR systems or future wireless communication systems. FR1 is a frequency range that includes 410 MHz-7125 MHz, which is often referred to (interchangeably) as “Sub-6 GHz”. FR3 is a frequency range that includes 7125 MHz-24,250 MHz. The receiver 300 may include amplifier circuitry 302a coupled between a plurality of antennas 304a, 304b (collectively 304) and a plurality of receive paths 306a, 306b. The antennas 304 may be arranged in different locations across a wireless communications device, for example, as further described herein with respect to FIG. 5. The antennas 304 may include a first antenna 304a and a second antenna 304b. In certain aspects, spatial diversity and/or antenna diversity may be enabled through additional amplifier circuitry. As an example, the second antenna 304b may be coupled to the amplifier circuitry 302a through optional, additional amplifier circuitry 302b, for example, via a respective switch circuit, as further described herein.

The receive paths 306a, 306b may include a first receive path 306a and a second receive path 306b. Each of the receive paths 306a, 306b may be an example of the receive path 222 of FIG. 2 or a portion thereof. For example, each of the receive paths 306a, 306b may include one or more amplifiers (such as the LNA 232), one or more mixers (such as the mixer 234), and/or one or more BBFs (such as the BBF 236).

The receiver 300 may include one or more processors (hereinafter “the processor 308”) and one or more memories (hereinafter “the memory 310”). The processor 308 may be an example of the modem 210 and/or the processor 212 of FIG. 2. The memory 310 may be an example of the memory 214 of FIG. 2. The processor 308 may be coupled to the amplifier circuitry 302a to control dynamic analog beamforming as described herein. Accordingly, the processor 308 may perform or implement the operations of the analog beamforming manager 106 of FIGS. 1 and 2 as further described herein.

The amplifier circuitry 302a may be included in one or more RF circuits or chips that is separate from an RF transceiver circuit or chip. As an example, the plurality of receive paths 306a, 306b may be included in a transceiver chip as described above, and the amplifier circuitry 302a may be included other circuits or chips arranged adjacent to the antenna to enable signal amplification and/or antenna switching proximate to the antennas 304. In some examples, the amplifier circuitry 302a is included in a module (e.g., a front end module) which packages together several chips or circuits, for example a chip implementing a first switch circuit 324, a chip implementing a second chip circuit 326, filters 320, and/or a chip implementing remaining components in the amplifier circuitry 302a. In certain cases, the amplifier circuitry 302a may include one or more power amplifiers (not shown), such as the PA 230. For example, multiple PAs may be coupled to the first switch circuit 324 such that the PAs can be coupled to respective antennas 304 to enable transmit beamforming and/or antenna diversity. In certain cases, the amplifier circuitry 302a may be included in the same RF circuit or chip that includes the plurality of receive paths 306a, 306b.

The amplifier circuitry 302a may include a plurality of amplifiers (e.g., including a first amplifier 312a and a second amplifier 312b), a plurality of phase shifters (e.g., including a first phase shifter 314a and a second phase shifter 314b), a RF combiner 316, and a plurality of circuit outputs (e.g., including a first circuit output 318a and a second circuit output 318b). The circuit outputs 318, 318b may be or include output ports, terminals, or pins of the amplifier circuitry 302a. In certain cases, the amplifier circuitry 302a may also include a plurality of RF filters (e.g., including a first RF filter 320a and a second RF filter 320b), a plurality of variable attenuators (e.g., including a first variable attenuator 322a and a second variable attenuator 322b), the first switch circuit 324, the second switch circuit 326, a first bypass path 328a, and a second bypass path 328b.

The amplifier circuitry 302a may include an array of signal paths selectively coupled to the antennas 304 via the first switch circuit 324. As an example, the first signal path may include the first RF filter 320a, the first amplifier 312a, the first phase shifter 314a, and the first variable attenuator 322a. The second signal path may include the second RF filter 320b, the second amplifier 312b, the second phase shifter 314b, and the second variable attenuator 322b. The circuit arrangement of the first signal path as further described herein may be an example of the circuit arrangement of the second signal path. The first switch circuit 324 may be coupled between the signal paths and the antennas 304. The first switch circuit 324 may be an antenna switch circuit used for enabling antenna diversity among multiple antennas. The first switch circuit 324 may selectively couple one or more antennas (such as the first antenna 304a) to at least one of the signal paths and/or bypass paths of the amplifier circuitry 302a. The first switch circuit 324 may be configured to selectively couple one or more antennas (e.g., the first antenna 304a and/or the second antenna 304b) to at least one of a plurality of amplifiers (e.g., the first amplifier 312a and the second amplifier 312b). The first switch circuit 324 may include one or more switches. In certain cases, the first switch circuit 324 may selectively couple one or more antennas routed through another amplifier circuitry. For example, the additional amplifier circuitry 302b may include a switch circuit (e.g., the first switch circuit 324) that selectively couples the second antenna 304b to the amplifier circuitry 302a.

In certain aspects, the first switch circuit 324 may be used for antenna sounding for characterization of a communication channel via a reference signal (e.g., a sounding reference signal) transmission through a transmit-receive antenna. For example, the first switch circuit 324 may be coupled to a transmitter (such as the TX path 218 of FIG. 2) to selectively couple the transmitter to an antenna used for transmission and reception.

As an example of the first signal path, the first RF filter 320a may be coupled between the first amplifier 312a and the first switch circuit 324. The first phase shifter 314a may be coupled between the first amplifier 312a and the RF combiner 316. In certain cases, a switch (not shown) may be coupled between the first amplifier 312a and the first phase shifter 314a in order to provide selective coupling between the first amplifier 312a and the first phase shifter 314a. The first variable attenuator 322a may be coupled between the first phase shifter 314a and the RF combiner 316. In certain cases, the first variable attenuator 322a may be coupled between the first amplifier 312a and the first phase shifter 314a. The first switch circuit 324 may feed a signal received via the first antenna 304a (or the second antenna 304b) to the first RF filter 320a, which may be or include a bandpass filter. The first RF filter 320a may allow a certain range of frequencies (e.g., an RF band) to pass and reject or attenuate frequencies outside the frequency band. The first RF filter 320a may feed the filtered signal to the first amplifier 312a. The first amplifier 312a may amplify the received signal and feed the amplified signal to the first phase shifter 314a and the second switch circuit 326 (for example, via the first bypass path 328a). The first amplifier 312a may be or include one or more low noise amplifiers. The first phase shifter 314a may apply a phase shift to the amplified signal and feed the phase shifted signal to the RF combiner 316. In certain cases, the first phase shifter 314a may feed the phase shifted signal to the first variable attenuator 322a. The first variable attenuator 322a may apply an adjustable gain (or attenuation) to the received signal, and the first variable attenuator 322a may feed the received signal to the RF combiner 316. In certain aspects, the first variable attenuator 322a may be or include one or more variable resistors (such as a switched array of resistors) and/or one or more transistors (for example, operated as a voltage controlled resistor).

The RF combiner 316 may combine the received signals fed through the signal paths via the first switch circuit 324. As an example, the RF combiner 316 may combine the power of the phase shifted signals fed through the first signal path and the second signal path of the signal paths into a combined signal. The respective phase shifters 314a, 314b and variable attenuators 322a, 322b of the first signal path and the second signal path may adjust the phase and amplitude of the received signals to be aligned or coherent in phase and amplitude (e.g., within a threshold difference ±5% or less) at the RF combiner 316. The processor 308 may control the phase shift and/or gain or attenuation adjustment applied at the respective phase shifter 314a, 314b and/or respective variable attenuator 322a, 322b. The RF combiner 316 may feed the combined signal to the second switch circuit 326. In certain cases, the second switch circuit 326 may selectively couple the output of the RF combiner 316 to the circuit output 318a and/or 318b of the amplifier circuitry 302a. In certain cases, the second switch circuit 326 may respectively couple the circuit output(s) 318a, 318b of the amplifier circuitry 302a to the bypass path(s) 328a, 328b (with the output 318a being coupled to the bypass path 328a and the output 318b being coupled to the bypass path 328b, or vice versa). In certain cases, the second switch circuit 326 may selectively couple one of the bypass paths 328a, 328b to both circuit outputs 318a, 318b. The second switch circuit may include one or more switches.

The amplifier circuitry 302a may operate in multiple states or modes, for example, including an analog beamforming mode and/or a bypass mode (e.g., without beamforming). The amplifier circuitry 302a may switch from operating in a first state (e.g., the bypass mode) to a second state (e.g., the analog beamforming mode) (or vice versa) based at least in part on various criteria. The criteria may depend on, for example, a received signal quality, a received signal strength, antenna diversity, the number of MIMO layers allocated for a transmission, a level of power usage for the transmission, and/or the like. In certain cases, the receiver 300 may operate in a hybrid mode where a first amplifier circuitry performs analog beamforming for a first MIMO layer and a second amplifier circuitry operates in a bypass mode for a second MIMO layer.

In the second state (e.g., the analog beamforming mode), the amplifier circuitry 302a may feed the combined signal from the RF combiner 316 to at least one receive path of the receive paths (such as the first receive path 306a) via at least one (or a single output) of the outputs 318a, 318b. The combined signal may carry the payload of a single MIMO layer of a transmission with one or more MIMO layers. The amplifier circuitry 302a may feed a first signal (from a first antenna) to the first phase shifter 314a via the first amplifier 312a and a second signal (from a second antenna) to the second phase shifter 314b via the second amplifier 312b based at least in part on switching from the first state to the second state of the receiver 300. As an example, the processor 308 may control which antennas feed received signals into the signal paths of the amplifier circuitry 302a via the first switch circuit 324 and which receive path 306 (e.g., of the transceiver chip) obtains the combined signal via the second switch circuit 326. In certain aspects, the amplifier circuitry 302a may operate in the analog beamforming mode, for example, opportunistically. The processor 308 may be coupled to the first switch circuit 324. For example, when the receiver 300 has antennas 304 and signal paths available for analog beamforming (for example, due to there being unused antennas or signal paths), the receiver may operate in the analog beamforming mode. The availability of antennas 304 and signal paths for analog beamforming may depend on the number of MIMO layers allocated or used for a transmission. The analog beamforming mode may be enabled or triggered when the number of MIMO layer(s) allocated or used for a transmission is less than the number of signal paths available for analog beamforming. The analog beamforming mode may allow the receiver 300 to achieve improved wireless communication performance, such as increased throughput, improved power consumption, additional levels of throughput, and/or the like.

In the first state (e.g., the bypass mode), the amplifier circuitry 302a may feed an amplified signal output by at least one of the amplifiers 312a, 312b to at least one of the receive paths 306a, 306b. The first bypass path 328a may be coupled between an output of the first amplifier 312a and a first input of the second switch circuit 326, and the second bypass path 328b may be coupled between an output of the second amplifier 312b and a second input of the second switch circuit 326. The amplified signal may carry the payload(s) of a single MIMO layer (or multiple MIMO layers) of a transmission with one or more MIMO layers. In the bypass mode, the amplifier circuitry 302a may feed a signal to the first circuit output 318a of the plurality of circuit outputs 318a, 318b via the first amplifier 312a while bypassing the first phase shifter 314a based at least in part on switching from the second state to the first state. As an example, the processor may select the amplified signal output by the first amplifier 312a to feed into the first receive path 306a via the second switch circuit 326. Accordingly, in the bypass mode, the amplifier circuitry 302a may feed, to a receive path 306, the amplified signal without analog beamforming while bypassing a phase shifter (for example, via the first bypass path 328a or the second bypass path 328b).

The second state may include a first number of MIMO layers, allocated to the receiver 300, being less than a threshold number of MIMO layers (e.g., 4, 6 or 8 MIMO layers). The first number of MIMO layers may be a subset of the MIMO layers supported by the receiver 300. The second state may include a first power level of the receiver 300 being less than a threshold power level. For example, the receiver 300 may enable analog beamforming to improve the signal quality of communications while conserving power by not using other receive paths (e.g., receive paths 306) for communications.

The second state may include a first number of active amplifiers being less than a threshold number of active or available amplifiers. An amplifier may be active when the amplifier is being used for signal amplification, and an amplifier may be inactive when the amplifier is in a low power state and/or not being used for signal amplification. The first number of active amplifiers may be less than the total number of amplifiers (e.g., LNAs) available at or included in the receiver 300.

The second state may include one or more properties associated with a signal received via the receiver 300 not satisfying a threshold, such as a threshold signal quality or signal strength. As an example, the second state may be enabled or triggered when the received signal strength or received signal quality via a single antenna (e.g., the first antenna) is less than or equal to the threshold signal strength or the threshold signal quality. The one or more properties may include one or more of a received signal quality or a received signal strength. The one or more properties may include, for example, a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), and/or a data error rate.

The first state may include a second number of MIMO layers, allocated to the receiver 300, being greater than or equal to the threshold number of MIMO layers. For example, the first state may be enabled or triggered based on there not being enough of antennas and/or signal paths for analog beamforming due to the total number of MIMO layers allocated for a transmission. The first state may include a second power level of the receiver 300 being greater than or equal to the threshold power level. The first state may include a second number of active amplifiers being greater than or equal to a threshold number of active amplifiers. The first state may include the one or more properties associated with the signal received via the receiver 300 satisfying the threshold. As an example, the first state may be triggered or enabled when the received signal strength or received signal quality via a single antenna (e.g., the first antenna) is greater than or equal to the threshold signal strength or the threshold signal quality.

In certain aspects, the antenna selection may be based on switching from the first state to the second state of the receiver 300. In the second state, the processor 308 may select the antennas 304, which feed the analog beamforming, via the first switch circuit 324 based on the signal quality and/or signal strength of the signals received via the respective antennas 304. As an example, the received signals obtained via the first antenna 304a and the second antenna 304b may provide the strongest signal qualities and/or signal strengths among the plurality of antennas 304, and the processor may control the first switch circuit 324 to feed the amplifiers 312a, 312b via the first antenna 304a and the second antenna 304b, respectively.

As an example, the first amplifier 312a may include a first input and a first output. The first input of the first amplifier 312a may be coupled to the first switch circuit 324, for example, via the first RF filter 320a. The first output of the first amplifier 312a may be selectively coupled to the first circuit output 318a or the second circuit output 318b of the plurality of circuit outputs 318a, 318b of the amplifier circuitry 302a.

The second amplifier 312b may include a second input and a second output. The second input of the second amplifier 312b may be coupled to the first switch circuit 324, for example, via the second RF filter 320b. The second output of the second amplifier 312b may be selectively coupled to the first circuit output 318a or the second circuit output 318b of the plurality of circuit outputs 318a, 318b of the amplifier circuitry 302a.

The first phase shifter 314a may include a third input and a third output. The third input of the first phase shifter 314a may be (selectively) coupled to the first output of the first amplifier 312a.

The second phase shifter 314b may include a fourth input and a fourth output. The fourth input of the second phase shifter 314b may be (selectively) coupled to the second output of the second amplifier 312b.

The RF combiner 316 may be or include an RF power combiner or current combiner, for example. The RF combiner 316 may include a fifth input, a sixth input, and a fifth output. The fifth input of the RF combiner 316 may be coupled to the third output of the first phase shifter 314a. The sixth input of the RF combiner 316 may be coupled to the fourth output of the second phase shifter 314b. The fifth output of the RF combiner 316 may be selectively coupled to at least one of the plurality of circuit outputs of the amplifier circuitry 302a, for example, via the second switch circuit 326.

The second switch circuit 326 may selectively couple the first output of the first amplifier 312a to the first circuit output 318a and/or the second circuit output 318b. The second switch circuit 326 may selectively couple the second output of the second amplifier 312b to the first circuit output 318a and/or the second circuit output 318b. The second switch circuit 326 may selectively couple the fifth output of the RF combiner 316 to the first circuit output 318a and/or the second circuit output 318b. In certain cases, the second switch circuit 326 may be or include a triple-pole double-throw switch.

In certain cases, the receiver 300 may include multiple amplifier circuits (e.g., multiple instances of the amplifier circuitry 302a) equipped for analog beamforming. For example, the receiver 300 may be capable of performing analog beamforming for multiple MIMO layers using the amplifier circuitry per MIMO layer among multiple MIMO layers.

While FIG. 3 illustrates that signals from two antennas may be selectively combined or routed over a bypass path(s), it will be understood that signals from more than two antennas may be selectively combined or routed over a bypass path(s). For example, the second switch circuit 326 may be coupled to three or more outputs 318, and the combiner 316 may be configured to combine three or more phase shifted signals. A corresponding number of bypass paths 328 may also be included.

Further, it will be understood that the bypass paths 328 may be configured to bypass additional or alternative components of the signal paths. For example, one or more of the bypass paths 328 may be configured to selectively bypass its respective amplifier 312 and/or its respective filter 320. In some examples, the first switch circuit 324 selectively routes a signal to a bypass path instead of the bypass path branching off another path.

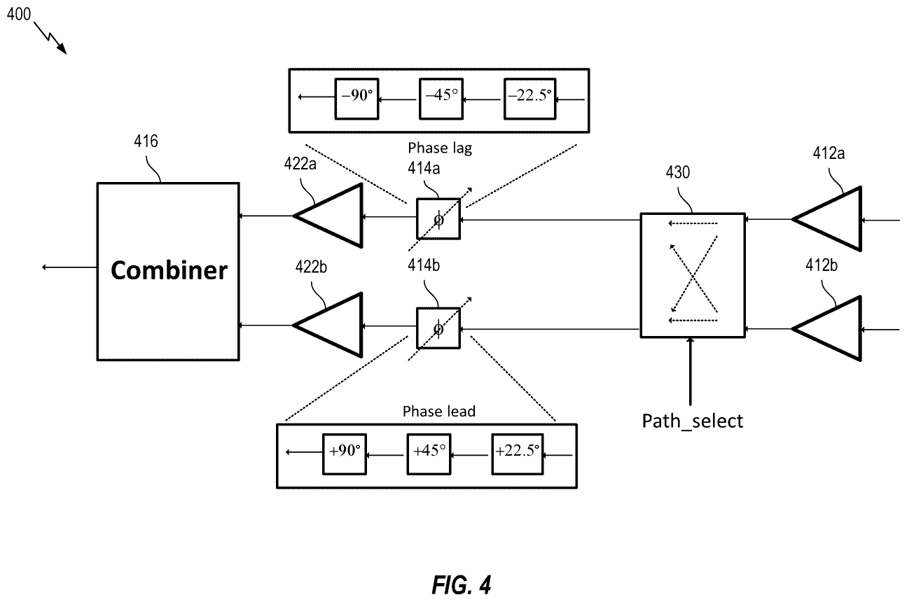

FIG. 4 depicts an example phase shifter architecture 400 for dynamic analog beamforming. In this example, the phase shifter architecture 400 may be an example arrangement of phase shifters included in a receiver, such as the receiver 300 and/or the amplifier circuitry 302a of FIG. 3. The phase shifter architecture 400 may include a plurality of phase shifters, such as a first phase shifter 414a and a second phase shifter 414b.

Each of the phase shifters 414a, 414b may be arranged in a separate signal path of a plurality of signal paths included in amplifier circuitry, such as the amplifier circuitry 302a of FIG. 3. For example, a first signal path may include a first amplifier 412a, the first phase shifter 414a, and a first variable attenuator 422a; and a second signal path may include a second amplifier 412b, the second phase shifter 414b, and a second variable attenuator 422b. The amplifier 412a, 412b may be examples of the amplifier 312a, 312b of FIG. 3, respectively. The variable attenuators 422a, 422b may be examples of the variable attenuators 322a, 322b of FIG. 3.

Each of the phase shifters 414a, 414b may be configured to apply a certain range or set of phase shifts to a signal (e.g., an RF signal). The first phase shifter 414a may be configured to apply a leading phase to a first signal, and the second phase shifter 414b may be configured to apply a lagging phase to a second signal. As an example, the first phase shifter 414a may be configured to apply a set of lagging phase shifts, such as phase shifts of −90°, −45°, and/or −22.5°. The second phase shifter 414b may be configured to apply a set of leading phase shifts, such as phase shifts of +90°, +45°, and/or +22.5°. Each of the phase shifters 414a, 414b may feed the respective phase shifted signal to an RF combiner 416, such as the RF combiner 316 of FIG. 3.

In certain cases, a switch circuit 430 may be coupled between the phase shifters 414a, 414b and the amplifiers 412a, 412b. The switch circuit 430 may allow a processor, such as the processor 308 of FIG. 3, to control which phase shifter among the first phase shifter 414a and the second phase shifter 414b is used to apply a phase shift to a signal received via a specific antenna. The switch circuit 430 may selectively couple the output of the first amplifier 412a to the input of either the first phase shifter 414a or the second phase shifter 414b. The switch circuit 430 may selectively couple the output of the second amplifier 412b to the input of either the first phase shifter 414a or the second phase shifter 414b. As an example, the processor may send a first control signal to the switch circuit 430 that causes the switch circuit 430 to couple the first amplifier 412a to the second phase shifter 414b and to couple the second amplifier 412b to the first phase shifter 414a. The processor may send, to each of the phase shifters (414a, 414b), a second control signal to set the phase shift applied to the received signal fed to the respective phase shifter 414a, 414b.

In certain aspects, the phase shifter selection may be based on a comparison between the RF signals received at the antennas (such as the first antenna 304a or the second antenna 304b of FIG. 3). As an example, when the phase of a first signal received via the first antenna (and fed to the first amplifier 412a) is less than the phase of a second signal received via the second antenna (and fed to the second amplifier 412b), the processor may control the switch circuit 430 to feed a first amplified signal (output by the first amplifier 412a) to the second phase shifter 414b (e.g., to apply a leading phase) and feed a second amplified signal (output by the second amplifier 412b) to the first phase shifter 414a (e.g., to apply a lagging phase). As another example, when the phase of a first signal received via the first antenna (and fed to the first amplifier 412a) is greater than the phase of a second signal received via the second antenna (and fed to the second amplifier 412b), the processor may control the switch circuit 430 to feed a first amplified signal (output by the first amplifier 412a) to the first phase shifter 414a (e.g., to apply a lagging phase) and feed a second amplified signal (output by the second amplifier 412b) to the second phase shifter 414b (e.g., to apply a leading phase).

Note that the phase shifter architecture 400 as depicted in FIG. 4 is an example circuit arrangement for phase shifters with leading-lagging configurations. In certain cases, the first switch circuit 324 of FIG. 3 may enable the phase shifter selection as described herein with respect to the switch circuit 430 of FIG. 4.

FIG. 5 depicts an example antenna architecture 500 for dynamic analog beamforming. In this example, a wireless communications device (such as the first wireless device 102) may include a plurality of antennas for wireless communications. The antennas 504a-g (collectively 504) may be arranged in different locations in or on a body 540 (or frame or enclosure) of the wireless device. In certain cases, the antennas 504 may be arranged on or adjacent to a back cover located opposite of a display of a portable wireless device, such as a cellphone or smartphone. The different locations may allow the antennas 504 to provide spatial diversity for wireless communications, such as when analog beamforming is enabled. The antennas 504 (or a subset thereof) may be coupled to amplifier circuitry, such as the amplifier circuitry 302a of FIG. 3.

As an example, the first antenna 504a and the third antenna 504c may be coupled to first amplifier circuitry 502a, such as the amplifier circuitry 302a of FIG. 3. The first amplifier circuitry 502a may include first switch circuitry 524b, such as the first switch circuitry 324, and the remaining component(s) that enable dynamic analog beamforming as described herein with respect to FIG. 3. The first antenna 504a and the third antenna 504c may be tuned for wireless communications in a first set of frequency bands (including, for example, band n77 used in 5G NR systems). In certain cases, the first amplifier circuitry 502a may perform analog beamforming using signals received via the first antenna 504a and the third antenna 504c. The fourth antenna 504d and the fifth antenna 504e may be coupled to second amplifier circuitry 502b, such as the additional amplifier circuitry 302b of FIG. 3. The second amplifier circuitry 502b may include second switch circuitry 524b, such as the first switch circuitry 324, and the remaining component(s) 540b that enable dynamic analog beamforming as described herein with respect to FIG. 3.

The first amplifier circuitry 502a may allow the first antenna 504a and/or the third antenna 504c to be routed or coupled to the second amplifier circuitry, via the first switch circuit 524a. The second amplifier circuitry 502b may allow the fourth antenna 504d and/or the fifth antenna 504e to be routed or coupled to the first amplifier circuitry 502a via the second switch circuitry 524b, for example, as described herein with respect to FIG. 3. For example, the first switch circuit 524a of the first amplifier circuitry 502a may be coupled between the first antenna 504a and/or the third antenna 504c and the second switch circuitry 524b of the second amplifier circuitry 502b. As another example, the second switch circuitry 524b of the second amplifier circuitry 502b may be coupled between the fourth antenna 504d and/or the fifth antenna 504e and the second switch circuitry 524b of the second amplifier circuitry 502b.

In certain cases, the first amplifier circuitry 502a may perform analog beamforming using signals received via the first antenna 504a, the third antenna 504c, the fourth antenna 504d, and/or the fifth antenna 504e, for example, via the selective coupling enabled through the first switch circuit 524a and/or the second switch circuit 524b. In certain cases, the second amplifier circuitry 502b may perform analog beamforming using signals received via the first antenna 504a, the third antenna 504c, the fourth antenna 504d, and/or the fifth antenna 504e, for example, the selective coupling enabled through the first switch circuit 524a and/or the second switch circuit 524b. As an example, the first amplifier circuitry 502a may perform analog beamforming using signals received via the first antenna 504a and the fifth antenna 504e; and the second amplifier circuitry 502b may perform analog beamforming using signals received via the third antenna 504c and the fourth antenna 504d (as depicted via the example switch routing of the first switch circuit 524a and the second switch circuit 524b).

In some examples, a signal from each of the antennas coupled to the amplifier circuitry 502a or 502b is passed through the respective circuitry without being phase shifted or combined. In some examples, one or more signals are coupled from one of the amplifier circuitry 502a, 502b to the other circuitry and then passed through the other circuitry without being phase shifted or combined. In such examples, four signals (in the illustrated embodiment) may be passed to respective RX paths (such as the receive paths 306).

In other examples, at least two signals are combined in one of the amplifier circuitry 502a, 502b. The signals may be combined in the circuitry to which the antennas which received the signals are coupled, or one or more of the signals may be coupled from one circuitry to the other before being combined. In such examples, two signals may be passed through at least one circuitry 502 without being phase shifted or combined and two signals may be phase shifted and combined (to be output to three RX paths), or two sets of two signals may be respectively phase shifted and combined (to be output to two RX paths).

In other examples, only two signals or three signals are received. These signals may be phase shifted and combined in any of various combinations, or may be maintained separate at least through the circuitry 502a and/or 502b.

In certain cases, the fourth antenna 504d and/or fifth antenna 504e may be tuned for wireless communications in the first set of frequency bands or a second set of frequency bands (including, for example, band n79 used in 5G NR systems), which may or may not overlap in the frequency domain with the first set of frequency bands. As an example, the second set of frequency bands may be arranged adjacent to the first set of frequency bands in the frequency domain.

In certain cases, the fourth antenna 504d and/or the fifth antenna 504e may be tuned for wireless communications in a set of frequency bands used for a different radio access technology (RAT) as the radio access technology used for the first antenna 504a and/or the third antenna 504c. For example, the fifth antenna 504e may be tuned to operate in the second set of frequency bands used for IEEE 802.11 communications, such as 2.4 GHz bands, 5 GHz bands, 6 GHz bands, and/or any future frequency bands. The analog beamforming described herein may be performed using antennas tuned in the same and/or different (e.g., adjacent) frequency band(s) and arranged in different locations of a wireless device. Accordingly, the analog beamforming may enable various receive beamforming schemes with antennas arranged in different locations of the wireless device and coupled to various amplifier circuitry with phase shifters to implement the beamforming, as described herein with respect to FIG. 3.

The amplifier circuitry 502a and/or 502b may be packaged into a respective circuit module (e.g., a chip, package, integrated circuit, and/or the like). In some cases, the amplifier circuitry 502a and/or 502b may be integrated in the same circuit module. In some examples, the first amplifier circuitry 502a is configured as a first module, and the second amplifier circuitry 502b is configured as a second module. Such modules may be coupled to a printed circuit board (PCB) (e.g., a motherboard, mainboard, logic board, or the like) or other board or chassis within, on, or at a wireless device (such as the first wireless device 102). The modules may be coupled by one or more traces or other routing on the PCB. While one persistent connection between the amplifier circuitry 502a and 502b may be illustrated (as a solid line) and one optional or alternative connection may be illustrated (with a dashed and dotted line), additional or alternative connection(s) between the amplifier circuitry may be implemented. For example, SRS_IN2 of either circuitry may be connected to SRS_OUT2 of the other circuitry. In some such examples, this allows signals from one or both antennas coupled to a respective circuitry to be routed to the other circuitry.

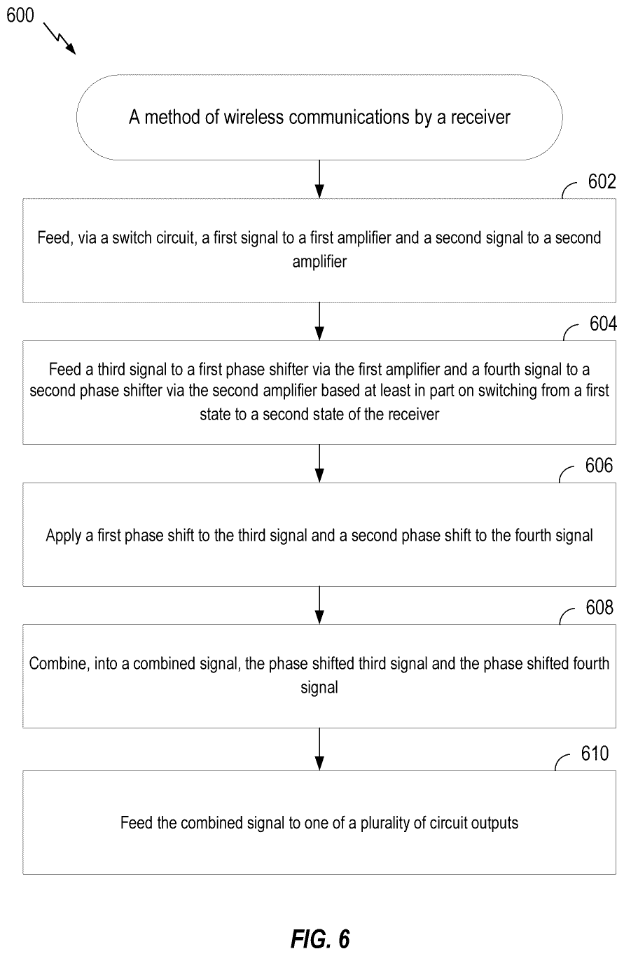

FIG. 6 illustrates example operations 600 for wireless communication. The operations 600 may be performed, for example, by a receiver (e.g., the receiver 300 of FIG. 3). The operations 600 may be implemented as software components that are executed and run on one or more processors (e.g., the modem 210 and/or the processor 212 of FIG. 2). Further, the transmission and/or reception of signals by the wireless device in the operations 600 may be enabled, for example, by one or more antennas (e.g., the antenna 220 of FIG. 2). In certain aspects, the transmission and/or reception of signals by the wireless device may be implemented via a bus interface of one or more processors (e.g., the modem 210 and/or the processor 212 of FIG. 2) obtaining and/or outputting signals for reception or transmission.

The operations 600 may optionally begin, at block 602, where the receiver may feed, via a switch circuit (e.g., the first switch circuit 324), a first signal to a first amplifier and a second signal to a second amplifier, for example, as described herein with respect to FIG. 3 and/or FIG. 5. In certain aspects, the first signal and the second signal may carry a payload of the same MIMO layer(s) of MIMO transmission.

At block 604, the receiver may feed a third signal to a first phase shifter via the first amplifier and a fourth signal to a second phase shifter via the second amplifier based at least in part on switching from a first state to a second state of the receiver, for example, as described herein with respect to FIG. 3.

At block 606, the receiver may apply a first phase shift to the third signal and a second phase shift to the fourth signal, for example, as described herein with respect to FIG. 3 and/or FIG. 4.

At block 608, the receiver may combine, into a combined signal, the phase shifted third signal and the phase shifted fourth signal, for example, as described herein with respect to FIG. 3.

At block 610, the receiver may feed the combined signal to one of a plurality of circuit outputs, for example, as described herein with respect to FIG. 3.

In certain aspects, the second state includes one or more of: a first number of multiple-input and MIMO layers, allocated to the receiver, being less than a threshold number of MIMO layers; a first power level of the receiver being less than a threshold power level; a first number of active amplifiers being less than a threshold number of active amplifiers; or one or more properties associated with the third signal not satisfying a threshold. In certain aspects, the one or more properties include one or more of a signal quality or a signal strength

In certain aspects, the receiver may feed the third signal to a first circuit output of the plurality of circuit outputs via the first amplifier while bypassing the first phase shifter based at least in part on switching from the second state to the first state. In certain aspects, the first state includes one or more of: a second number of MIMO layers, allocated to the receiver, being greater than or equal to the threshold number of MIMO layers; a second power level of the receiver being greater than the threshold power level; a second number of active amplifiers being greater than a threshold number of active amplifiers; or the one or more properties associated with the first signal satisfying the threshold.

In certain aspects, the receiver may couple the first amplifier to a first antenna, via the switch circuit, and couple the second amplifier to a second antenna, via the switch circuit, based at least in part on switching from the first state to the second state of the receiver. The receiver may feed the first signal to the first amplifier via a first antenna and the second signal to the second amplifier via a second antenna based at least in part on switching from the first state to the second state of the receiver, for example, using the first switch circuit of FIG. 3. Different states of the receiver may use a different number of signal paths of amplifier circuitry (e.g., the amplifier circuitry 302a of FIG. 3) to meet certain performance specifications, such as received signal quality, received signal strength, throughput, power consumption, and/or the like. For example in the case of two MIMO layers, two to four signal paths of amplifier circuitry may be used with analog beamforming. By dynamically beamforming different antennas with different number of signal paths of amplifier circuitry, various receiver states may be implemented, for example, in terms of different levels of received signal quality, received signal strength, throughput, power consumption, and/or the like. In certain aspects, a plurality of antennas are selectively coupled to one or more of the first amplifier or the second amplifier, wherein the plurality of antennas comprises the first antenna and the second antenna.

In certain aspects, the receiver comprises a plurality of amplifiers comprising the first amplifier and the second amplifier; a plurality of phase shifters comprising the first phase shifter selectively coupled to at least the first amplifier, and the second phase shifter selectively coupled to at least the second amplifier; and a radio frequency combiner coupled to the plurality of phase shifters.

Aspects of the present disclosure may be applied to any of various wireless communication devices that may perform dynamic analog beamforming described herein.

### Example Aspects

Implementation examples are described in the following numbered clauses:

Aspect 1: A receiver configured for wireless communications, comprising: a plurality of amplifiers comprising a first amplifier and a second amplifier; a first switch circuit coupled to the plurality of amplifiers, wherein the first switch circuit is configured to selectively couple one or more antennas to at least one of the plurality of amplifiers; a plurality of phase shifters comprising a first phase shifter coupled to at least the first amplifier, and a second phase shifter coupled to at least the second amplifier; a radio frequency combiner coupled to the plurality of phase shifters; one or more memories; and one or more processors coupled to the one or more memories, the first phase shifter, and the second phase shifter, the one or more processors being configured to cause the receiver to: feed a first signal to the first phase shifter via the first amplifier and a second signal to the second phase shifter via the second amplifier based at least in part on switching from a first state to a second state of the receiver; apply a first phase shift to the first signal and a second phase shift to the second signal; combine, into a combined signal, the phase shifted first signal and the phase shifted the second signal; and feed the combined signal to one of a plurality of outputs.

Aspect 2: The receiver of Aspect 1, wherein: the first amplifier includes a first input and a first output, the first output being selectively coupled to a first circuit output of the plurality of outputs; the second amplifier includes a second input and a second output, the second output being selectively coupled to a second circuit output of the plurality of outputs; the first phase shifter includes a third input and a third output, the third input being selectively coupled to the first output of the first amplifier; the second phase shifter includes a fourth input and a fourth output, the fourth input being selectively coupled to the second output of the second amplifier; and the radio frequency combiner includes a fifth input, a sixth input, and a fifth output, wherein the fifth input is coupled to the third output of the first phase shifter, the sixth input is coupled to the fourth output of the second phase shifter, and the fifth output is selectively coupled to at least one of the plurality of outputs.

Aspect 3: The receiver of Aspect 2, further comprising a plurality of receive paths comprising a first receive path coupled to the first circuit output and a second receive path coupled to the second circuit output.

Aspect 4: The receiver of Aspect 2 or 3, further comprising a second switch circuit configured to: selectively couple the first output of the first amplifier to the first circuit output, selectively couple the second output of the second amplifier to the second circuit output, and selectively couple the fifth output of the radio frequency combiner to the first circuit output or the second circuit output.

Aspect 5: The receiver according to any of Aspects 1-4, wherein the second state includes one or more of: a first number of multiple-input and multiple-output (MIMO) layers, allocated to the receiver, being less than a threshold number of MIMO layers; a first power level of the receiver being less than a threshold power level; a first number of active amplifiers being less than a threshold number of active amplifiers; or one or more properties associated with the first signal not satisfying a threshold.

Aspect 6: The receiver of Aspect 5, wherein the one or more properties include one or more of a signal quality or a signal strength.

Aspect 7: The receiver of Aspect 5 or 6, wherein the one or more processors are configured to cause the receiver to feed a third signal to a first circuit output of the plurality of outputs via the first amplifier while bypassing the first phase shifter based at least in part on switching from the second state to the first state.

Aspect 8: The receiver of Aspect 7, wherein the first state includes one or more of: a second number of MIMO layers, allocated to the receiver, being greater than or equal to the threshold number of MIMO layers; a second power level of the receiver being greater than the threshold power level; a second number of active amplifiers being greater than a threshold number of active amplifiers; or the one or more properties associated with the first signal satisfying the threshold.

Aspect 9: The receiver according to any of Aspects 1-8, further comprising: a first attenuator coupled between the first phase shifter and the radio frequency combiner; and a second attenuator coupled between the second phase shifter and the radio frequency combiner.

Aspect 10: The receiver according to any of Aspects 1-9, further comprising a plurality of antennas selectively coupled, via the first switch circuit, to one or more of the first amplifier or the second amplifier, wherein the plurality of antennas comprises a first antenna and a second antenna.

Aspect 11: The receiver of Aspect 10, wherein the one or more processors are configured to cause the receiver to feed a third signal to the first amplifier via the first antenna and a fourth signal to the second amplifier via the second antenna based at least in part on switching from the first state to the second state of the receiver.

Aspect 12: The receiver according to any of Aspects 1-11, further comprising a second switch circuit configured to: selectively couple the first amplifier to the first phase shifter or the second phase shifter and selectively couple the second amplifier to the first phase shifter or the second phase shifter, wherein the first phase shifter is configured to apply a leading phase to a first signal, and the second phase shifter is configured to apply a lagging phase to a second signal.

Aspect 13: A method of wireless communications by a receiver, comprising: feeding, via a switch circuit, a first signal to a first amplifier and a second signal to a second amplifier; feeding a third signal to a first phase shifter via the first amplifier and a fourth signal to a second phase shifter via the second amplifier based at least in part on switching from a first state to a second state of the receiver; applying a first phase shift to the third signal and a second phase shift to the fourth signal; combining, into a combined signal, the phase shifted third signal and the phase shifted fourth signal; and feeding the combined signal to one of a plurality of circuit outputs.

Aspect 14: The method of Aspect 13, wherein the second state includes one or more of: a first number of multiple-input and multiple-output (MIMO) layers, allocated to the receiver, being less than a threshold number of MIMO layers; a first power level of the receiver being less than a threshold power level; a first number of active amplifiers being less than a threshold number of active amplifiers; or one or more properties associated with the third signal not satisfying a threshold.

Aspect 15: The method of Aspect 14, wherein the one or more properties include one or more of a signal quality or a signal strength.

Aspect 16: The method of Aspect 14 or 15, further comprising feeding the third signal to a first circuit output of the plurality of circuit outputs via the first amplifier while bypassing the first phase shifter based at least in part on switching from the second state to the first state.

Aspect 17: The method of Aspect 16, wherein the first state includes one or more of: a second number of MIMO layers, allocated to the receiver, being greater than or equal to the threshold number of MIMO layers; a second power level of the receiver being greater than the threshold power level; a second number of active amplifiers being greater than a threshold number of active amplifiers; or the one or more properties associated with the third signal satisfying the threshold.

Aspect 18: The method according to any of Aspects 13-17, further comprising coupling the first amplifier to a first antenna, via the switch circuit, and coupling the second amplifier to a second antenna, via the switch circuit, based at least in part on switching from the first state to the second state of the receiver.

Aspect 19: The method of Aspect 18, wherein a plurality of antennas are selectively coupled to one or more of the first amplifier or the second amplifier, via the switch circuit, wherein the plurality of antennas comprises the first antenna and the second antenna.

Aspect 20: The method according to any of Aspects 13-19, wherein the receiver comprises: a plurality of amplifiers comprising the first amplifier and the second amplifier; a plurality of phase shifters comprising the first phase shifter selectively coupled to at least the first amplifier, and the second phase shifter selectively coupled to at least the second amplifier; and a radio frequency combiner coupled to the plurality of phase shifters.

Aspect 21: An apparatus, comprising: a memory; and one or more processors configured to perform a method in accordance with any of Aspects 13-20.

Aspect 22: An apparatus, comprising means for performing a method in accordance with any of Aspects 13-20.

Aspect 23: A non-transitory computer-readable medium comprising computer-executable instructions that, when executed by one or more processors of a processing system, cause the processing system to perform a method in accordance with any of Aspects 13-20.

Aspect 24: A computer program product embodied on a computer-readable storage medium comprising code for performing a method in accordance with any of Aspects 13-20.

Aspect 25: A method of manufacturing an apparatus configured for wireless communications, comprising: making a receiver in accordance with any of Aspects 1-19.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a microcontroller, a microprocessor, a general purpose processor, an artificial intelligence (AI) processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), a system in package (SiP), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one or more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

1. A receiver configured for wireless communications, comprising:
a plurality of amplifiers comprising a first amplifier and a second amplifier;
a first switch circuit coupled to the plurality of amplifiers, wherein the first switch circuit is configured to selectively couple one or more antennas to at least one of the plurality of amplifiers;
a plurality of phase shifters comprising a first phase shifter coupled to at least the first amplifier, and a second phase shifter coupled to at least the second amplifier;
a radio frequency combiner coupled to the plurality of phase shifters;
one or more memories; and
one or more processors coupled to the one or more memories, the first phase shifter, and the second phase shifter, the one or more processors being configured to cause the receiver to:
feed a first signal to the first phase shifter via the first amplifier and a second signal to the second phase shifter via the second amplifier based at least in part on switching from a first state to a second state of the receiver;
apply a first phase shift to the first signal and a second phase shift to the second signal;
combine, into a combined signal, the phase shifted first signal and the phase shifted the second signal; and
feed the combined signal to one of a plurality of circuit outputs.

2. The receiver of claim 1, wherein:
the first amplifier includes a first input and a first output, the first output being selectively coupled to a first circuit output of the plurality of circuit outputs;
the second amplifier includes a second input and a second output, the second output being selectively coupled to a second circuit output of the plurality of circuit outputs;
the first phase shifter includes a third input and a third output, the third input being selectively coupled to the first output of the first amplifier;
the second phase shifter includes a fourth input and a fourth output, the fourth input being selectively coupled to the second output of the second amplifier; and
the radio frequency combiner includes a fifth input, a sixth input, and a fifth output, wherein the fifth input is coupled to the third output of the first phase shifter, the sixth input is coupled to the fourth output of the second phase shifter, and the fifth output is selectively coupled to at least one of the plurality of circuit outputs.

3. The receiver of claim 2, further comprising a plurality of receive paths comprising a first receive path coupled to the first circuit output and a second receive path coupled to the second circuit output.

4. The receiver of claim 2, further comprising a second switch circuit configured to: selectively couple the first output of the first amplifier to the first circuit output, selectively couple the second output of the second amplifier to the second circuit output, and selectively couple the fifth output of the radio frequency combiner to the first circuit output or the second circuit output.

5. The receiver of claim 1, wherein the second state includes one or more of:
a first number of multiple-input and multiple-output (MIMO) layers, allocated to the receiver, being less than a threshold number of MIMO layers;
a first power level of the receiver being less than a threshold power level;
a first number of active amplifiers being less than a threshold number of active amplifiers; or
one or more properties associated with the first signal not satisfying a threshold.

6. The receiver of claim 5, wherein the one or more properties include one or more of a signal quality or a signal strength.

7. The receiver of claim 5, wherein the one or more processors are configured to cause the receiver to feed a third signal to a first circuit output of the plurality of circuit outputs via the first amplifier while bypassing the first phase shifter based at least in part on switching from the second state to the first state.

8. The receiver of claim 7, wherein the first state includes one or more of:
a second number of MIMO layers, allocated to the receiver, being greater than or equal to the threshold number of MIMO layers;
a second power level of the receiver being greater than the threshold power level;
a second number of active amplifiers being greater than a threshold number of active amplifiers; or
the one or more properties associated with the first signal satisfying the threshold.

9. The receiver of claim 1, further comprising:
a first attenuator coupled between the first phase shifter and the radio frequency combiner; and
a second attenuator coupled between the second phase shifter and the radio frequency combiner.

10. The receiver of claim 1, further comprising a plurality of antennas selectively coupled, via the first switch circuit, to one or more of the first amplifier or the second amplifier, wherein the plurality of antennas comprises a first antenna and a second antenna.

11. The receiver of claim 10, wherein the one or more processors are configured to cause the receiver to feed a third signal to the first amplifier via the first antenna and a fourth signal to the second amplifier via the second antenna based at least in part on switching from the first state to the second state of the receiver.

12. The receiver of claim 1, further comprising a second switch circuit configured to: selectively couple the first amplifier to the first phase shifter or the second phase shifter and selectively couple the second amplifier to the first phase shifter or the second phase shifter, wherein the first phase shifter is configured to apply a leading phase to a first signal, and the second phase shifter is configured to apply a lagging phase to a second signal.

13. A method of wireless communications by a receiver, comprising:
feeding, via a switch circuit, a first signal to a first amplifier and a second signal to a second amplifier;
feeding a third signal to a first phase shifter via the first amplifier and a fourth signal to a second phase shifter via the second amplifier based at least in part on switching from a first state to a second state of the receiver;
applying a first phase shift to the third signal and a second phase shift to the fourth signal;
combining, into a combined signal, the phase shifted third signal and the phase shifted fourth signal; and
feeding the combined signal to one of a plurality of circuit outputs.

14. The method of claim 13, wherein the second state includes one or more of:
a first number of multiple-input and multiple-output (MIMO) layers, allocated to the receiver, being less than a threshold number of MIMO layers;
a first power level of the receiver being less than a threshold power level;
a first number of active amplifiers being less than a threshold number of active amplifiers; or
one or more properties associated with the third signal not satisfying a threshold.

15. The method of claim 14, wherein the one or more properties include one or more of a signal quality or a signal strength.

16. The method of claim 14, further comprising feeding the first signal to a first circuit output of the plurality of circuit outputs via the first amplifier while bypassing the first phase shifter based at least in part on switching from the second state to the first state.

17. The method of claim 16, wherein the first state includes one or more of:
a second number of MIMO layers, allocated to the receiver, being greater than or equal to the threshold number of MIMO layers;
a second power level of the receiver being greater than the threshold power level;
a second number of active amplifiers being greater than a threshold number of active amplifiers; or
the one or more properties associated with the third signal satisfying the threshold.

18. The method of claim 13, further comprising coupling the first amplifier to a first antenna, via the switch circuit, and coupling the second amplifier to a second antenna, via the switch circuit, based at least in part on switching from the first state to the second state of the receiver.

19. The method of claim 18, wherein a plurality of antennas are selectively coupled to one or more of the first amplifier or the second amplifier, via the switch circuit, wherein the plurality of antennas comprises the first antenna and the second antenna.

20. The method of claim 13, wherein the receiver comprises:
a plurality of amplifiers comprising the first amplifier and the second amplifier;
a plurality of phase shifters comprising the first phase shifter selectively coupled to at least the first amplifier, and the second phase shifter selectively coupled to at least the second amplifier; and
a radio frequency combiner coupled to the plurality of phase shifters.
